(19) United States
(12) Patent Application Publication
(10) Pub. No.: US 2008/0059067 A1
(43) Pub. Date: Mar. 6, 2008

(54) GPS navigation system and method thereof

(75) Inventors: Juhang Kuo, Taipei (TW); Wei-Tsu Yang, Taipei County (TW)

Correspondence Address: BIRCH STEWART KOLASCH & BIRCH, PO BOX 747, FALLS CHURCH, VA, 22040-0747, US

(73) Assignee: Mitac International Corp.

(21) Appl. No.: 11/896,775

(22) Filed: Sep. 5, 2007

(30) Foreign Application Priority Data
Sep. 6, 2006 (TW) 095132948

(51) Int. Cl. G01C 21/00; G01C 21/20

(52) U.S. Cl. 701/213

(57) ABSTRACT

A system and method of GPS navigation are used for guiding a group of mobile platforms. Through an initiation negotiation process, primarily platforms and the secondary platforms are selected from the mobile platforms to form a peer-to-peer (P2P) network. Each of the secondary platforms are connected to one of the primarily platform to transfer communication data containing GPS data to the correspondingly connected primarily platform. Then each primarily platform collects the communication data received from the correspondingly connected secondary platforms, and exchange data with the other primarily platforms. Exchanged data are transmitted to every secondary platform; therefore every mobile platform receives GPS data of the others, thus the mobile platforms are guided based on the communication data containing the GPS data.

### CROSS-REFERENCE TO RELATED APPLICATIONS

This non-provisional application claims priority under 35 U.S.C. § 119(a) on Patent Application No(s). 095132948 filed in Taiwan, R.O.C. on Sep. 6, 2006, the entire contents of which are hereby incorporated by reference.

### BACKGROUND

1. Field of Invention

The invention relates to navigation, and in particular to a navigation system and method, for guiding a group of mobile platforms.

2. Related Art

The Global Positioning System (GPS) is a kind of Positioning System which obtains the position coordinate of a target by receiving the positioning signals transmitted from a plurality of satellites. In general, such a system includes three parts: satellites, ground stations, and receiving devices. The ground stations provide the supervision and management of satellites; the satellites transmit the positioning signals to the earth, and the receiving devices receive and process the positioning signals to derive position coordinate. Furthermore, by monitoring variation of the positioning signals, the receiving devices also derive the speed, the local time, the altitude of the receiving devices. Usually, positioning signals from four or more satellites are required for deriving the three dimensional position and the time deviation relative to a fixed coordinate system of the receiving devices. As such, the GPS is a global, all-weather, speed and time measuring, and real-time positioning system.

With the progress of science, and the rapid development of wireless positioning and navigation technology, the GPS has been widely utilized in military, transportation, target tracking, and outdoor activities. As such, the GPS provides great facilities and convenience, such that people may acquire their positions directly through the satellite signals received from satellites.

When GPS is utilized in a plurality of mobile platforms that belong to a group, each of the mobile platforms may be equipped with a GPS receiver, and the GPS receiver can be only used to derive its own position, thus not being able to know the positions of GPS receivers of other members in the same group, therefore resulting in difficulties in the communication of the members of the same group. For example, when people engaging in outdoor activities, some of the members may drop out or leave the group for various reasons, thus causing problems relating to their safety for not being able to acquire their positions.

Thus, there exist certain difficulties and limitations in the communication and verification relating to their respective positions among the members of a group of GPS users. Though, usually, the members in a group of GPS users may inquire other members of the group about their approximate positions through other mobile communication technologies, such as Global System for Mobile Communication (GSM) or General Packet Radio Service (GPRS) of wireless communication by using of wireless handheld mobile communication devices. However, for unfamiliar geographic environment, there is no way of truly knowing for certain the exact positions of those GPS member users. Moreover, this scenario is further restricted and limited by the characteristics of the wireless communication of GSM and GPRS. In the situation of entirely having no GSM or GPRS signals, the communications among GPS member users may exists greater problems and difficulties. And in particular, in some dangerous or emergency conditions, the above-mentioned problems will be more pronounced.

Therefore, the establishment of a reliable communication channel among members of a group of GPS users, so that each of group members may accurately and timely realizes his/her geographic location, thus realizing the communication between each other even in the environment of not having the GSM or GPRS signals, is an important and urgent task that must be solved in this field.

### SUMMARY OF THE INVENTION

In view of the above-mentioned problems, the objective of the invention is to provide a GPS (Global Positioning System) navigation system and method for guiding a group having a plurality of mobile platforms, thus solving the problems and limitations of the prior arts.

To achieve the above-mentioned objective, a GPS navigation system of the present invention is provided, which includes a plurality of mobile platform. Firstly, an initiation negotiation process is performed. In the initiation negotiation process, each mobile platform sends a request to at least one of the other mobile platforms, such that the mobile platforms connect to each other. Then the mobile platforms are divided into a plurality of primarily platforms and a plurality of secondary platforms, and the primarily platforms and the secondary platform form a peer-to-peer network through the initiation negotiation process. The primarily platforms are selected from the mobile platforms, to serve as primarily nodes in the peer-to-peer network through the initiation negotiation process. The other mobile platforms are secondary platforms to serve as secondary nodes in the peer-to-peer network through the initiation negotiation process. Each of the secondary platforms is connected to one of the primarily platform. The initiation negotiation process is activated according to the requests sent by the mobile platforms, to determine which one of the mobile platforms is a primarily platform and which one of the mobile platform is secondary platform. In the system of the invention communication data including GPS data are transmitted from the secondary nodes to the correspondingly connected primarily node after the secondary platforms being connected to the correspondingly connected primarily platforms. Then, the received communication data including GPS data are exchanged among the primarily nodes through the peer-to-peer network. Finally, the exchanged communication data including the GPS data are transmitted from each of the primarily nodes to the correspondingly connected secondary nodes. Therefore, each of the mobile platforms receives GPS data of the others, thus the mobile platforms are guided based on the communication data containing the GPS data.

By applying the aforementioned system, a GPS navigation method of the invention is provided. According to the method, an initiation negotiation process is performed according to the requests sent by the mobile platforms at first. Then a plurality of primarily platforms selected from the mobile platforms to serve as primarily nodes and a plurality of secondary platforms selected from the other mobile platforms to serve as secondary nodes are determined according the initiation negotiation process, and a peer-to-peer network is also formed by the mobile platforms. Each of the secondary nodes is connected to one of the primarily platforms, and communication data including GPS data of the secondary nodes are transmitted to the correspondingly connected primarily platform. The primarily platforms exchange the received communication data including GPS data with each other. Finally, the exchanged communication data including GPS data are transmitted from each of the primarily nodes to the correspondingly connected secondary nodes. Therefore, each of the mobile platforms receives GPS data of the others, thus the mobile platforms are guided based on the communication data containing the GPS data to guide the group having the mobile platforms.

According to the system and the method of the present invention, the peer-to-peer network is established and the GPS data of a mobile platform is transmitted to the other mobile platforms, and the mobile platform receives the GPS data of all the other mobile platforms. Direct connections among the mobile platforms without having to go through other specific mediator are established, thus the GPS data can be exchanged and shared, thereby achieving the transmission of the geographic information among the mobile platforms.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow for illustration only, and thus are not limitative of the invention, and wherein:

FIG. 1 is a schematic diagram of a GPS navigation system of the invention;

FIG. 2 is a system block diagram of a primarily platform and a secondary platform of a GPS navigation system of the invention; and

FIG. 3 is a flowchart illustrates the steps of a GPS navigation method of the invention.

### DETAILED DESCRIPTION OF THE INVENTION

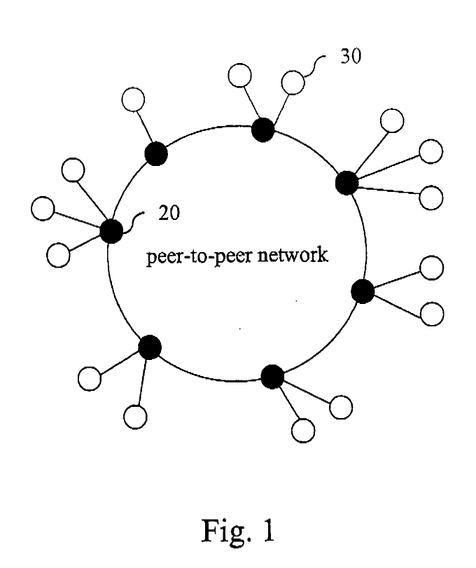

Referring to FIG. 1, a schematic diagram of a GPS navigation system of the present invention is shown. The GPS navigation system includes a plurality of mobile platforms. An initiation negotiation process is performed. In the initiation negotiation process, each mobile platform sends a request to at least one of the other mobile platforms, such that the mobile platforms connect to each other. Then the mobile platforms are divided into a plurality of primarily platforms and a plurality of secondary platforms, and the primarily platforms and the secondary platform form the peer-to-peer network through the initiation negotiation process. The mobile platforms include a plurality of primarily platforms 20 selected from the mobile platforms and a plurality of secondary platforms 30 selected from the other mobile platforms. In FIG. 1, the dark spots represent the primarily platforms 20 while the white spots represent the secondary spots 30. The primarily platforms 20 (dark spots) and the secondary platform 30 (white spots) are selected and determined through the initiation negotiation process. As shown in FIG. 1, the primarily platforms 20 are selected to serve as primarily nodes in the peer-to-peer network through the initiation negotiation process, and the secondary platforms 30 are selected to serve as secondary nodes in the peer-to-peer network through the initiation negotiation process, Each of the secondary platforms 30 is connected to one of the primarily platforms 20, and each of the primarily platforms 20 is connected to at least one of the other primarily platforms 20. That is, the peer-to-peer network includes sets of mobile platforms, each set includes a primarily platforms 20 and several secondary platforms 30 connected to the primarily platform 20 of the same set, while the primarily platform 20 is connected to at least one primarily platform 20 of the other set. Therefore, the peer-to-peer network is established among the mobile platforms, thus being capable of performing data transmission and exchange of various communication data among the mobile platforms.

The above-mentioned initiation negotiation process is used to connect the mobile platforms to each other, and is used to determine which mobile platform is primarily platform 20 and which mobile platform is secondary platform 30. The initiation negotiation process is activated according to the requests sent by the mobile platforms. The requests are in forms of Short Message Service (SMS) or Instant Message (IM) packets, and are sent through Global System for Mobile (GSM) Communications or exchanged data packets of third-party instant message software. When the requests are sent by the mobile platforms, the initiation negotiation process is activated, and then the peer-to-peer network is form by the mobile platforms, as shown in FIG. 1. The detail of the initiation negotiation process of the peer-to-peer network is well known in the prior art, and that will not be described hereafter.

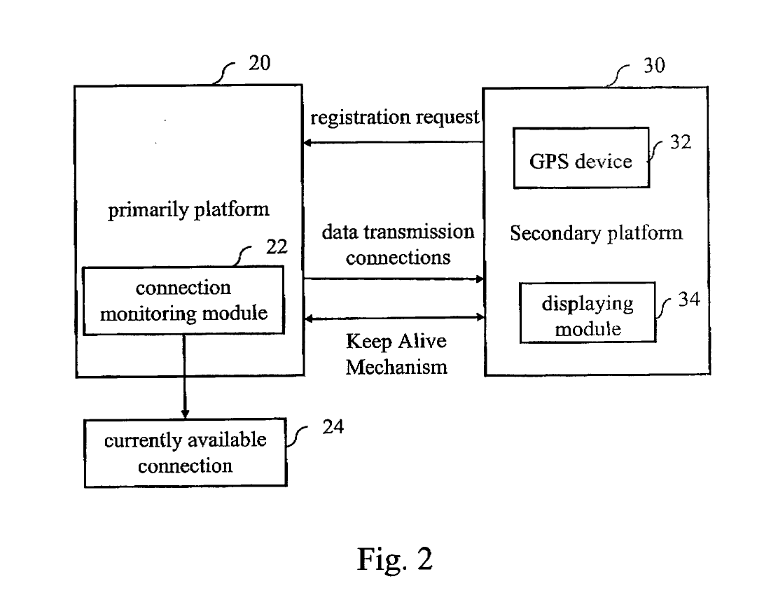

Referring to FIG. 2, a system block diagram of a primarily platform 20 and a secondary platform 30 is shown. Both the primarily platform 20 and the secondary platform 30 perform a Keep Alive Mechanism. By performing the Keep Alive Mechanism, periodic packets are exchanged between the primarily platform 20 and the corresponding secondary platforms 30, or among the primarily platforms 20 themselves, so as to ensure the GPS navigation system is normally functioned. When a secondary platform 30 is offline from the navigation system, then the correspondingly connected primarily platform 20 in informed through the Keep Alive Mechanism, thus keeping the accuracy of the navigation platform. Alternatively, when a primarily platform 20 is offline from the navigation system, the initiation negotiation process is reactivated to determining a new primarily platform 20 to be connected to the secondary platforms 30 which were previously connected to the offline primarily platform 20, in the navigation system. Furthermore, if an abnormal disconnection occurs to a primarily platform 20, then the Keep Alive Mechanism of the secondary platforms 30 under the supervision of primarily platform 20 reactivate an initiation negotiation process for forming a new peer-to-peer network.

After the secondary platforms 30 being connected to the correspondingly connected primarily platform 20, each the secondary platforms 30 send a registration request to one of the primarily platforms 20. The registration of the secondary platforms 30 to more than one primarily platforms 20 ensures the normal operation of the navigation system in case of an abnormal disconnection generates for a primarily platform 20. The subject of registration of the secondary platforms 30 is obtained by an algorithm of the initiation negotiation process, and it is not necessarily for a secondary platforms 30 to register itself to the correspondingly connected primarily platform 20, the secondary platforms 30 may register itself to the other primarily platform 20. However, when the other primarily platforms 20 receive such a registration request, the registration request of the secondary platforms 30 is transferred to the correspondingly connected primarily platform 20, and the other primarily platforms 20 will also make response to the registered secondary platforms 30. As such, the Keep Alive Mechanism ensures the peer-to-peer network normally functioned.

Referring to FIG. 1 and FIG. 2, to simplify the description, only one primarily platform 20 and one secondary platform 30 of a GPS navigation system are shown in the FIG. 2. The secondary platform 30 in FIG. 2 is one of a plurality of secondary platforms 30 connected correspondingly to the primarily platform 20. To be more specific, the connection relations and operation principle of a primarily platform 20 an secondary platform 30 having multiple connection relations as shown in FIG. 1 are the same as those of the primarily platform 20 and secondary platform 30 as shown in FIG. 2. As such, it will not be repeated here for brevity.

As shown in FIG. 2, the primarily platform 20 has a connection monitoring module 22 for detecting the status of the currently available connections 24 between a primarily platform 20 and its correspondingly connected secondary platform 30, so as to determine a connection mode between the primarily platform 20 and the secondary platform 30. The connection mode includes one of the following wireless communication protocols, such as General Packet Radio Service (GPRS), Wireless Local Area Network (WLAN), Worldwide Interoperability for Microwave Access (WiMax), and third generation mobile service (3G mobile service), to establish a data transmission connections between primarily platform 20 and secondary platform 30, that is used to proceed with the transmission of the various data including the GPS data.

The connection monitoring module 22 also determines a pertinent connection mode for data transmission through calculating the distance between primarily platform 20 and secondary platform 30. When a mobile platform is located at a place where GSM or GPRS signals can not be received, the utilization of the originally selected available connections would lead to the disconnection of data transmission between the primarily platform 20 and the secondary platform 30. In this case, the connection monitoring module 22 automatically selects a currently available connection to replace the afore-mentioned data transmission connection, so as to re-establish the connection between the primarily platform 20 and the secondary platform 30. Therefore, even through there are no GSM or 3G signals available, the navigation system is normally functioned, as long as the mobile platforms is within the range of any kind of wireless communication. In addition, the primarily platform 20 in the peer-to-peer serves as a base platform together with the registration response of the secondary platform 30, thus the normal operation of the navigation platform will not be affected even a temporary disconnection occurs for the secondary platform 30.

Upon establishing the data transmission channel between the primarily platform 20 and the secondary platform 30, the secondary platform 30 is used to transmit the communication data, such as the GPS data, connection status and other character, voice, and image data to the corresponding primarily platform 20. In order to realize navigating a group of platforms, the GPS data is essential. For this purpose, the primarily platform 20 receives and collects the communication data received from secondary platform 30. In the invention, Session Initiation Protocol (SIP) is utilized to store the relative positions of the various platforms including the secondary platforms 30 in the navigation system and the information transmitted to the secondary platform 30. Upon collecting the communication data received from the various correspondingly connected secondary platforms 30 including this particular secondary platform 30, the primarily platform 20 exchanges data with the other primarily platforms 20 through the peer-to-peer network as shown in FIG. 1. Naturally, in this process, the primarily platform 20 also receives data sent from other primarily platforms 20, and transmit them to the secondary platforms 30 connected to it, thus realizing the communication between/among the plurality of mobile platforms.

In addition, the secondary platform 30 further includes a GPS device 32 for obtaining the GPS positioning data thereof by receiving and processing the GPS signal sent from the GPS satellites. But, the GPS device 32 is necessarily required by every secondary platforms 30. In that case, the secondary platform 30 may only receive the information sent from other mobile platforms. By receiving the communication data containing GPS data, the secondary platform 30 transmits it directly to a display module 34 contained therein. The display module 34 transforms the coordinate data in GPS data into a map and displays it on a screen. Meanwhile, the display module 34 may also transform the coordinate data into position data and then display it in a form of character, for a user to realize the current positions of other mobile platforms relative to this mobile platform.

FIG. 2 illustrates the communication mode for the connection between a primarily platform 20 and a secondary platform 30 connected to each other. The communication mode for the connections between various primarily platforms 20 including this particular primarily platform 20 is similar to that as shown in FIG. 2. The only difference is that, the connection monitoring module 22 of the primarily platform 20 may be used to detect the currently available connection status of the various primarily platforms 20, thus determining the connection mode between the primarily platforms 20. Moreover, the connection monitoring module 22 of the primarily platform 20 may be used to select the pertinent connection mode through calculating the distances between the primarily platforms 20.

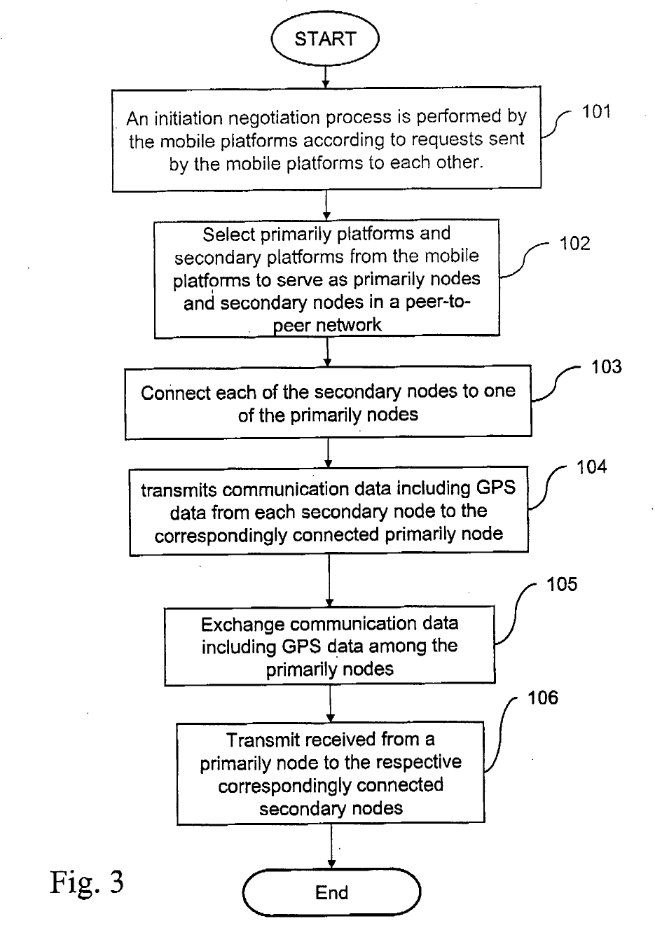

FIG. 3 is a flowchart of the steps of a GPS group navigation method for guiding a group of the invention. An initiation negotiation process is performed by the mobile platforms according to requests sent by the mobile platforms to each other at first (step 101). The requests are in forms of Short Message Service (SMS) or Instant Message (IM) packets to activating the initiation negotiation process. And a peer-to-peer network is also formed by the mobile platforms through the initiation negotiation process. Next, according to the initiation negotiation process, the mobile platforms negotiate to each other. A plurality of primarily platforms 20 are selected from the mobile platforms to serve as primarily nodes in the peer-to-peer network, and a plurality of secondary platforms 30 are selected form the other mobile platforms to serve as secondary nodes in the peer-to-peer network (step 102). Then, connect each of the secondary nodes to one of the primarily nodes through the initiation negotiation process (step 103). After the peer-to-peer network is formed, each mobile platform detects the currently available connection status between each primarily node and the correspondingly connected secondary nodes, so as to determine the connection mode of connections between the primarily nodes and the correspondingly connected secondary nodes, and also between the primarily nodes themselves, so as to determine the pertinent connection modes to the other mobile platforms. Or each mobile platform calculates the distances between each primarily node and the correspondingly connected secondary nodes, and also between the primarily nodes, so as to determine the pertinent connection modes to the other mobile platforms. In this step, at least one of the wireless communication protocols such as GPRS, WLAN, WiMax or 3G can be selected as the pertinent connection mode.

Subsequently, each secondary platform 30 (secondary node) transmits communication data including GPS data to the correspondingly connected primarily platform 20 (primarily node) through Session Initiation Protocol (SIP) (step 104). Each primarily node collects the communication data containing the GPS data received from the respective correspondingly connected secondary nodes, and then exchange data with the other primarily nodes (step 105) through the peer-to-peer network, thus dada is exchanged among the primarily nodes. Then, the exchange data received from other primarily nodes by the primarily node are transmitted to the respective correspondingly connected secondary nodes (step 106), thus every mobile platform receiving GPS data of all the other mobile platforms, thus the mobile platforms are guided based on the communication data containing the GPS data.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A GPS navigation system for guiding a group of mobile platforms, comprising:
a plurality of mobile platforms forming a peer-to-peer network through an initiation negotiation process among the mobile platforms, and including
a plurality of primarily platforms selected from the mobile platforms to serve as primarily nodes in the peer-to-peer network through the initiation negotiation process; and
a plurality of secondary platforms selected from the other mobile platforms, and connected to each of the primarily platform respectively to serve as secondary nodes in the peer-to-peer network, through the initiation negotiation process, wherein the initiation negotiation process is activated according to requests sent by the mobile platforms; and
wherein communication data including GPS data are transmitted from the secondary nodes to the correspondingly connected primarily nodes after the secondary platforms being connected to the correspondingly connected primarily platforms, the communication data including the GPS data received by the primarily nodes are exchanged to each other through the peer-to-peer network, then the exchanged communication data containing the GPS data are transmitted to the secondary nodes, thus the mobile platforms are guided based on the communication data containing the GPS data.

2. The GPS navigation system as claimed in claim 1, wherein the requests for activating the initiation negotiation process are in form of Short Message Service or Instant Message packets.

3. The GPS navigation system as claimed in claim 1, wherein the primarily platforms and the secondary platforms exchange data with each other through a Session Initiation Protocol.

4. The GPS navigation system as claimed in claim 1, wherein each of the primarily platforms comprises a connection monitoring module for detecting currently available connection statuses to the correspondingly connected secondary nodes, or calculating the distances between each of the primarily nodes and each of the correspondingly connected secondary nodes, so as to determine a connection mode for the connections among the primarily node and the correspondingly connected secondary nodes, and also among each of the primarily nodes.

5. The GPS group navigation system as claimed in claim 4, wherein the connection mode is selected from the group of wireless communication protocols consisting of General Packet Radio Service, Wireless Local Area Network, Worldwide Interoperability for Microwave Access, and third generation mobile service.

6. The GPS group navigation system as claimed in claim 1, wherein each of the primarily platforms and each of the secondary platforms perform a Keep Alive Mechanism respectively.

7. The GPS group navigation system as claimed in claim 1, wherein each of the secondary platform sends a registration request to one of the primarily nodes after forming the peer-to-peer network.

8. A GPS navigation method for guiding a group of mobile platforms, comprising the following steps:
performing an initiation negotiation process according to requests sent by the mobile platforms;
according to the initiation negotiation process, determining a plurality of primarily platforms selected from the mobile platforms to serve as primarily nodes, and determining a plurality of secondary platforms selected from the other mobile platforms to serve as secondary nodes, thus forming a peer-to-peer network;
connecting each of the secondary nodes to one of the primarily nodes through the initiation negotiation process;
transmitting communication data containing GPS data from each of the secondary nodes to the correspondingly connected primarily nodes;
exchanging said communication data containing said GPS data received among the primarily nodes through the peer-to-peer network; and
transmitting said exchanged communication data containing said GPS data from each of the primarily node to the correspondingly connected secondary nodes, thus the mobile platforms are guided based on the communication data containing the GPS data.

9. The GPS group navigation method as claimed in claim 8, wherein the requests for activating the initiation negotiation process are in a form of Short Message Service or Instant Message packets.

10. The GPS navigation method as claimed in claim 8, wherein the primarily platforms and the secondary platforms exchange data with each other through a Session Initiation Protocol.

11. The GPS navigation method as claimed in claim 8, wherein the step of connecting each of the secondary nodes to one of the primarily nodes further includes the step of detecting the currently available connection statuses to the correspondingly connected secondary nodes, or calculating the distance from each of the primarily nodes to each of correspondingly connected secondary nodes, so as to determine a connection modes for the connections among the primarily nodes and the correspondingly connected secondary nodes, and also among each of primarily nodes.

12. The GPS group navigation method as claimed in claim 11, wherein said connection mode is selected from the group of wireless communication protocols consisting of General Packet Radio Service, Wireless Local Area Network, Worldwide Interoperability for Microwave Access, and third generation mobile service.

13. The GPS group navigation method as claimed in claim 8, wherein said at least one primarily platforms and each of the secondary platforms perform a Keep Alive Mechanism respectively.

14. The GPS group navigation method as claimed in claim 8, further comprising the step of: sending a registration request from the secondary platform to one of the primarily nodes after forming the peer-to-peer network.
